(19) United States
(12) Patent Application Publication
(10) Pub. No.: US 2021/0198467 A1
(43) Pub. Date: Jul. 1, 2021

(54) RUBBER COMPOSITION FOR TIRE INNER LINER AND PNEUMATIC TIRE

(71) Applicant: Toyo Tire Corporation, Itami-shi (JP)

(72) Inventor: Keisuke Mogari, Itami-shi (JP)

(73) Assignee: Toyo Tire Corporation, Itami-shi (JP)

(21) Appl. No.: 17/130,400

(22) Filed: Dec. 22, 2020

(30) Foreign Application Priority Data
Dec. 25, 2019 (JP) 2019-234920

(51) Int. Cl. C08L 23/28; C08L 91/00; B60C 1/00

(52) U.S. Cl. CPC C08L 23/28; C08K 3/04; B60C 1/0008; C08L 91/00

(57) ABSTRACT

A rubber composition for a tire inner liner according to an embodiment contains a rubber component containing halogenated butyl rubber, a carbon black, a pulverized bituminous coal, and an aliphatic/aromatic copolymer petroleum, resin. A pneumatic tire according to the embodiment includes an inner liner formed of the rubber composition for a tire inner liner.

### CROSS-REFERENCE TO RELATED APPLICATIONS

This application is based upon and claims the benefit of priority from the prior Japanese Patent Application No. 2019-234920, filed on Dec. 25, 2019; the entire contents of which are incorporated herein by reference.

### BACKGROUND

### 1. Technical Field

The present disclosure relates to a rubber composition used as an inner liner for a pneumatic tire, and a pneumatic tire using the same.

### 2. Description of Related Art

An inner liner is provided on an inner surface of a pneumatic tire as an air permeation preventing layer in order to keep the tire air pressure constant. A butyl-based rubber having excellent air permeability resistance is used as a rubber component in the rubber composition forming such an inner liner, and various proposals have been made so far.

For example, JP-A-2018-002872 proposes to blend oil, resin, and an inorganic filler in a specific amount to a rubber component containing butyl rubber and halogenated butyl rubber in order to improve the air permeation prevention performance without deteriorating fatigue resistance, low temperature embrittlement and vulcanization failure. JP-A-2019-104779 proposes to blend a specific carbon black, a layered or platy mineral, and a resin having a glass transition temperature of 41 to 75° C. with a rubber component containing butyl rubber in order to improve gas barrier property and low temperature durability.

### SUMMARY

However, JP-A-2018-002872 and JP-A-2019-104779 do not describe a combination of a pulverized bituminous coal and an aliphatic/aromatic copolymer petroleum resin, and are not always sufficient in terms of gas barrier property and flexural fatigue resistance at low temperature.

Meanwhile, in general, during tire forming, the rubber composition for an inner liner is formed into a sheet shape by a roll, an extruder, and the like, and the obtained sheet-like material is wound into a tubular shape on a tire forming drum as an inner liner. A green tire (unvulcanized tire) is produced by attaching a carcass ply on the inner liner, further attaching each tire member such as a belt, tread rubber, and sidewall rubber on the carcass ply, and inflating (expanding) these members- By vulcanizing and molding the green tire in a mold, a pneumatic tire can be obtained. Here, the matching portion (joint portion) between a winding start tip and a winding end tip of the inner liner wound in a tubular shape may be Partially peeled off after the expansion described above to generate an opening, which causes poor tire forming.

Therefore, in the rubber composition for a tire inner liner, it is required to prevent the opening of the joint portion of the inner liner during tire forming, as well as air permeability resistance (that is, gas barrier property) and flexural fatigue resistance at a low temperature.

An object of the present disclosure is to provide a rubber composition for a tire inner liner capable of preventing the opening of the joint portion of the inner liner during tire forming while improving air permeability resistance and flexural fatigue resistance at low temperatures, and a pneumatic tire using the same.

A rubber composition for a tire inner liner according to an embodiment of the present disclosure contains a rubber component containing halogenated butyl rubber, a carbon black, a pulverized bituminous coal, and an aliphatic/aromatic copolymer petroleum resin.

The pneumatic tire according to an embodiment of the present disclosure includes an inner liner formed of the rubber composition for a tire inner liner.

### DESCRIPTION OF EMBODIMENTS

A rubber composition for a tire inner liner according to an embodiment (hereinafter, also simply referred to as “rubber composition”) is formed by blending a carbon black, a pulverized bituminous coal, and an aliphatic/aromatic copolymer petroleum resin with a rubber component containing halogenated butyl rubber. According to the present embodiment, it is possible to prevent the opening of the joint portion of the inner liner during tire forming while improving the air permeability resistance and the flexural fatigue resistance at a low temperature.

The rubber component contains the halogenated butyl rubber from the viewpoint of air permeability resistance. Examples of the halogenated butyl rubber include brominated butyl rubber (BIIR) and chlorinated butyl rubber (CIIR), and either one of the rubbers may be used alone or in combination.

The rubber component may be halogenated butyl rubber alone, or may be a blend of halogenated butyl rubber and other rubbers such as butyl rubber. The ratio of the halogenated butyl rubber in the rubber component is preferably 70% by mass or more, and preferably 80% by mass or more.

As the other rubbers to be used in combination with the halogenated butyl rubber, butyl rubber (XIR) is preferred from the viewpoint of air permeability resistance, although a diene rubber such as natural rubber (NR), isoprene rubber (IR), butadiene rubber (BR), and styrene-butadiene rubber (SBR) may be used as long as the effects of the present disclosure are not impaired.

The carbon black is blended as a reinforcing filler, and various known kinds can be used. It is preferable to use a carbon black having a nitrogen adsorption specific surface area (N₂SA) (JIS K6217-2) of 20 to 70 m²/g, and more preferably a carbon black having a nitrogen adsorption specific surface area (N₂SA) of 20 to 50 m²/g. Specifically, the FEF class (N500 series) and the GPF class (N600 series) (both ASTM grade) carbon blacks are exemplified. Any one of the carbon blacks or a combination of two or more thereof can be used.

The amount of carbon black is not particularly limited, but is preferably 10 to 70 parts by mass, more preferably 20 to 60 parts by mass, and may be 30 to 50 parts by mass with respect to 100 parts by mass of the rubber component.

The pulverized bituminous coal is obtained by pulverizing bituminous coal which is a type of coal. In this example, the bituminous coal is classified into B₁, B₂ and C according to the classification of coal according to JIS M1002. The average particle size of the pulverized bituminous coal (ASTM D1511 compliant: measured using Microtrac SRA 150, manufactured by Microtrac Bel Inc.) is not particularly limited, but is preferably 0.5 to 100 μm, and more preferably 1 to 30 μm.

For such a pulverized bituminous coal, a commercially available product can be used, and the examples thereof include “Austin Black 325” manufactured by Coal Fillers, Inc.

The amount of the pulverized bituminous coal is preferably 5 to 30 parts by mass, and more preferably 10 to 30 parts by mass with respect to 100 parts by mass of the rubber component. When the amount of the pulverized bituminous coal is 5 parts by mass or more, by combining with aliphatic/aromatic copolymer petroleum resin, it is possible to enhance air permeability resistance and flexural fatigue resistance at low temperature, while increasing the effect of preventing the opening of the joint portion. When the amount of the pulverized bituminous coal is 30 parts by mass or less, it is possible to increase the effect of preventing the opening of the joint portion.

The aliphatic/aromatic copolymer petroleum resin is also referred to as C5/C9 copolymerized petroleum resin. More specifically, the aliphatic/aromatic copolymer petroleum resin is a resin obtained by copolymerizing a C5 fraction and a C9 fraction, and may be hydrogenated or modified. Here, the C5 fraction is a petroleum fraction equivalent to 4 to 5 carbon atoms, and examples of the C5 fraction include isoprene, pentene, methylbutene, piperylene, cyclopentene, and cyclopentadiene The C9 fraction is a petroleum fraction equivalent to 8 to 10 carbon atoms, and examples of the C9 fraction include styrene, vinyltoluene, alkylstyrene, and indene.

The aliphatic/aromatic copolymer petroleum resin is blended as a tackifier to impart stickiness to the rubber composition, and by blending with the pulverized bituminous coal, it is possible to prevent the opening of the joint portion while improving the air permeability resistance and the flexural fatigue resistance at low temperature. Specifically, there is excellent air permeability resistance compared to the case of using aliphatic petroleum resin (C5 resin) obtained by polymerizing the C5 fraction. There are excellent air permeability resistance and flexural fatigue resistance at low temperatures compared to the case of using aromatic petroleum resin (C9 resin) obtained by polymerizing the C9 fraction. There is good processability, and the effect of preventing the opening of the joint portion of the inner liner during tire forming is excellent.

The softening point of the aliphatic/aromatic copolymer petroleum resin is preferably 90 to 110° C. More preferably, the softening point is 90 to 105° C. When the softening point is 90° C. or higher, the air permeability resistance can be improved, and when the softening point is 110° C. or lower, deterioration of flexural fatigue resistance can be prevented. Here, the softening point is a value measured by a ring and ball type method in accordance with JIS K2207.

From the viewpoint of the effects described above, the amount of the aliphatic/aromatic copolymer petroleum resin is preferably 0.1 to 20 parts by mass with respect to 100 parts by mass of the rubber component. The amount of the aliphatic/aromatic copolymer petroleum resin is preferably 0.5 parts by mass or more, and more preferably 1 part by mass or more, and preferably 15 parts by mass or less.

In the rubber composition according to the present embodiment, in addition to the components described above, various additives generally used in the rubber composition, such as oil, zinc oxide, stearic acid, age resister, wax, vulcanizing agent, and vulcanization accelerator can be blended.

For the oil, various oils generally blended in the rubber composition can be used. For example, mineral oils, that is, at least one mineral oil selected from the group consisting of paraffin oils, naphthenic oils, and aroma oils maybe used. The content of the oil is not particularly limited, and may be 10 parts by mass or less (may not be blended), or 1 to 5 parts by mass with respect to 100 parts by mass of the rubber component, for example.

For the vulcanizing agent, sulfur is preferably used. The amount of the vulcanizing agent is not particularly limited, but is preferably 3 parts by mass or less (may not be blended), and more preferably 0.1 to 2 parts by mass with respect to 100 parts by mass of the rubber component. Examples of the vulcanization accelerator include various vulcanization accelerators such as sulfanamide, thiuram, tniazole, and guanidine, and any one of the vulcanization accelerator may be used alone or in combination of two or more kinds thereof. The amount of the vulcanization accelerator is not particularly limited, but is preferably 0.1 to 5 parts by mass, and more preferably 0.5 to 3 parts by mass with respect to 100 parts by mass of the rubber component.

The rubber composition according to the present embodiment can be produced by kneading with a commonly used mixing machine, such as a Banbury mixer, a kneader, or a roll, according to a related method. For example, in a first mixing step (nonproductive mixing step), the carbon black, pulverized bituminous coal, and aliphatic/aromatic copolymer petroleum resin, and additives other than the vulcanizing agent and the vulcanization accelerator are added and mixed with the rubber component. Next, in a final mixing step (productive mixing step), an unvulcanized rubber composition can be prepared by adding and mixing the vulcanizing agent and the vulcanization accelerator to the obtained mixture.

The obtained rubber composition can be used as a rubber composition forming an inner liner of a pneumatic tire. For example, a sheet-like material is formed by a roll, an extruder, and the like, and the sheet-like material is wound on a tire forming drum as an inner liner according to a related method. A green tire (unvulcanized tire) is produced by attaching a carcass ply on the inner liner, further attaching each tire member such as a belt, tread rubber, and sidewall rubber on the carcass ply, and inflating (expanding) these members. By vulcanizing and molding the green tire in a mold at, for example, 140 to 180° C., a pneumatic tire including an inner liner formed of a thin rubber layer on the inner surface of the tire can be obtained. The thickness of the inner liner varies according to the tire size, and the like, but Is usually 0.5 to 3 mm.

According to the present embodiment, as described above, by blending the rubber component containing halogenated butyl rubber with the pulverized bituminous coal and the aliphatic/aromatic copolymer petroleum resin together, it is possible to prevent, the opening of the joint portion of the inner liner during tire forming while improving air permeability resistance and flexural fatigue resistance at low temperatures.

The application of the pneumatic tire is not particularly limited, but includes, as an example, various applications such as passenger cars and heavy loading for trucks and buses, and can be-used for pneumatic tires of various sizes.

### EXAMPLES

Hereinafter, certain embodiments are described below, but the present disclosure is not construed as being limited to these examples.

First, using a Bunbury mixer, according to the composition (part by mass) shown in Table 1 below, in the first mixing step, the compounding agents excluding sulfur and the vulcanization accelerator were added to the rubber component and kneaded (discharge temperature=160° C.). Next, in the final mixing step, sulfur and the vulcanization accelerator were added to the obtained kneaded product and kneaded (discharge temperature=90° C.). As a result, a rubber composition for a tire inner liner was prepared.

The details of each components in Table 1 are as follows.
Brominated butyl rubber: “Bromobutyl 2222” manufactured by ExxonMobil Chemical Company.
Carbon black: “SEAST V” manufactured by Tokai Carbon Co., Ltd. (N₂SA: 27 m²/g)
Pulverized bituminous coal: “Austin Black 325” manufactured by Coal Fillers, Inc. (average particle size: 5.5 μm)
Petroleum resin 1: Aliphatic petroleum resin, “Escorez 1102” manufactured by ExxonMobil Chemical Company.
Petroleum resin 2: Aliphatic/aromatic copolymer petroleum resin, “Petrotack 90” manufactured by Tosoh Co., Ltd. (containing a constituent unit derived from indene, styrene and vinyltoluene, and a constituent unit derived from piperylene. Softening point: 95° C.)
Oil: “NC-140” manufactured by JXTG Energy Corporation.
Zinc oxide: “Zinc Oxide 3 Species” manufactured by Mitsui Mining & Smelting Co., Ltd.
Stearic acid: “BEADS STEARIC ACID” manufactured by NOF Corp.
Vulcanization accelerator: “NOCCELER-DM-P” manufactured by Ouchi Shinko Chemical Industrial Co., Ltd.
Sulfur: “5%-Oil Filled Powdered Sulfur” manufactured by Tsurumi Chemical Industry Co., Ltd.

Each of the obtained rubber compositions was evaluated for air permeability resistance and low temperature flexural fatigue resistance using a sample vulcanized at 160° C. for 30 minutes. The opening property of the joint portion at the time of producing a green tire was evaluated for each rubber composition. Each measurement and evaluation method is as follows.
Air permeability resistance: The air permeability was measured by a gas permeability tester (“BT-3” manufactured by Toyo Seiki Seisaku-sho Co., Ltd.) using a vulcanized rubber sheet having a thickness of 1 mm as a sample, and the reciprocal of the measured value was indicated by an index with the value of Comparative Example 1 as being 100. It is demonstrated that as the numerical value is larger, the air permeability resistance is better.
Low temperature flexural fatigue resistance: According to JIS K6260, a crack growth test was conducted in an environment of −35° C. using a De Mattia flex test device, and the number of times of flexing until the crack length reached 10 mm was measured. An index was represented relative to the number of flexing in Comparative Example 1 as being 100, and it is demonstrated that, as the numerical value is greater, the low temperature flexural fatigue resistance is better.
Joint opening property: 1000 green tires (tire size: 11R22.5) were produced using each rubber composition as an inner liner, and the presence of opening in the joint portion of the inner liner was examined. Regarding the number of green tires with opening, based on the number of occurrences in Comparative Example 1, it was evaluated as “A” for a decrease of 20% or more, “B” for a decrease of 10% or more and less than 20%, “C” for a decrease of 1% or more and less than 10%, and “D” for no decrease or increase.

TABLE 1

| | Com.1 | Ex.. 1 | Ex. 2 | Ex. 3 | Ex. 4 | Ex. 5 | Ex. 6 |
|---|---|---|---|---|---|---|---|
| Composition | | | | | | | |
| (parts by | | | | | | | |
| mass) | | | | | | | |
| Brominated | 100 | 100 | 100 | 100 | 100 | 100 | 100 |
| butyl rubber | | | | | | | |
| Carbon black | 50 | 50 | 50 | 50 | 50 | 50 | 30 |
| Pulverized | 10 | 10 | 10 | 10 | 10 | 10 | 30 |
| bituminous | | | | | | | |
| coal | | | | | | | |
| Petroleum | 3 | — | — | — | — | — | — |
| resin 1 | | | | | | | |
| Petroleum | — | 1 | 3 | 5 | 10 | 15 | 5 |
| resin 2 | | | | | | | |
| Oil | 5 | 5 | 5 | 5 | 5 | 5 | 5 |
| Zinc oxide | 3 | 3 | 3 | 3 | 3 | 1 | 3 |
| Stearic acid | 1 | 1 | 1 | 1 | 1 | 1 | 1 |
| Vulcanization | 2 | 2 | 2 | 2 | 2 | 2 | 2 |
| accelerator | | | | | | | |
| Sulfur | 0.5 | 0.5 | 0.5 | 0.5 | 0.5 | 0.5 | 0.5 |
| Evaluation | | | | | | | |
| Air | 100 | 115 | 121 | 127 | 138 | 145 | 140 |
| permeability | | | | | | | |
| resistance | | | | | | | |
| Low | 100 | 120 | 126 | 130 | 140 | 130 | 120 |
| temperature | | | | | | | |
| flexural | | | | | | | |
| fatigue | | | | | | | |
| resistance | | | | | | | |
| Joint | — | A | A | A | B | C | C |
| opening | | | | | | | |
| property | | | | | | | |

The results are shown in Table 1. Compared to Comparative Example 1 in which the pulverized bituminous coal and the aliphatic petroleum resin were combined, in Examples 1 to 6 in which the pulverized bituminous coal and the aliphatic/aromatic copolymer petroleum resin are combined, air permeability resistance and flexural fatigue resistance at low temperatures were greatly improved, and opening at the joint portion was also prevented.

While certain embodiments have been described, these embodiments have been presented by way of example only, and are not intended to limit the scope of the disclosures. Indeed, these embodiments described herein may be embodied in a variety of other forms; furthermore, various omissions, substitutions and changes in the form of the embodiments described herein may be made without departing from the spirit of the disclosures These embodiments, omissions, replacements, changes, and the like thereof are included in the scope and gist of the disclosure, as well as in the scope of the disclosure described in the claims and the equivalent scope thereof.

What is claimed is:

1. A rubber composition for a tire inner liner, comprising a rubber component containing halogenated butyl rubber, a carbon black, a pulverized bituminous coal, and an aliphatic/aromatic copolymer petroleum resin.

2. The rubber composition for a tire inner liner according to claim 1, containing 5 to 30 parts by mass of the pulverized bituminous coal, and 0.1 to 20 parts by mass of the aliphatic/aromatic copolymer petroleum resin, with respect to 100 parts by mass of the rubber component.

3. The rubber composition for a tire inner liner according to claim 1, wherein a ratio of the halogenated butyl rubber to the rubber component is 70% by mass or more.

4. The rubber composition for a tire inner liner according to claim 1, wherein the carbon black has a nitrogen adsorption specific surface area of 20 to 70 m²/g.

5. The rubber composition for a tire inner liner according to claim 2, containing 10 to 70 parts by mass of the carbon black with respect to 100 parts by mass of the rubber component.

6. The rubber composition for a tire inner liner according to claim 1, wherein the aliphatic/aromatic copolymer petroleum resin has a softening point of 90 to 110° C.

7. A pneumatic tire comprising an inner liner containing the rubber composition for a tire inner liner according to claim 1.

8. A pneumatic tire comprising an inner liner containing the rubber composition for a tire inner liner according to claim 2.

9. A pneumatic tire comprising an inner liner containing the rubber composition for a tire inner liner according to claim 3.

10. A pneumatic tire comprising an inner liner containing the rubber composition for a tire inner liner according to claim 4.

11. A pneumatic tire comprising an inner liner containing the rubber composition for a tire inner liner according to claim 5.

12. A pneumatic tire comprising an inner liner containing the rubber composition for a tire inner liner according to claim 6.
